(19) United States
(12) Patent Application Publication
(10) Pub. No.: US 2020/0287671 A1
(43) Pub. Date: Sep. 10, 2020

(54) BLOCK-IFDMA MULTIPLEXING SCHEME WITH FLEXIBLE PAYLOAD

(71) Applicant: NOKIA SOLUTIONS AND NETWORKS OY, Espoo (FI)

(72) Inventors: Kari Juhani HOOLI, Oulu (FI); Timo Erkki LUNTTILA, Espoo (FI); Esa Tapani TIIROLA, Kempele (FI)

(21) Appl. No.: 16/081,987

(22) PCT Filed: Mar. 2, 2017
(86) PCT No.: PCT/EP2017/054897

§ 371 Date: Sep. 4, 2018

(30) Foreign Application Priority Data
Mar. 4, 2016 (EP) PCT/EP2016/054661

(51) Int. Cl. H04L 5/00; H04J 11/00

(52) U.S. Cl. CPC H04L 5/0007; H04J 2211/008; H04J 11/00

(57) ABSTRACT

Various communication systems may benefit from multiplexing schemes. For example, various wireless communication systems may benefit from a block-IFDMA multiplexing scheme with a flexible payload. A method can include determining whether a first type of uplink signal or a second type of uplink signal is to be processed for transmission on an interlace. The method can also include determining whether to apply spreading based on intra-symbol spreading codes, inter-symbol spreading codes, or both intra-symbol spreading codes and inter-symbol spreading codes, based on the determination of whether the first type of uplink signal or the second type of uplink signal is to be processed for transmission. The method can further include causing transmission of the determined at least one of the first type of uplink signal and the second type of uplink signal according to the determination regarding applying spreading.

### BACKGROUND

### Field

Various communication systems may benefit from multiplexing schemes. For example, various wireless communication systems may benefit from a block-IFDMA multiplexing scheme with a flexible payload.

### Description of the Related Art

Release 13 (Rel-13) Long Term Evolution (LTE) Licensed Assisted Access (LAA) aims to provide licensed-assisted access to unlicensed spectrum while coexisting with other technologies and fulfilling regulatory requirements. In Rel-13 LAA, unlicensed spectrum is utilized to improve LTE downlink (DL) throughput. In the conventional approach, one or more LAA DL secondary cell (SCell) may be configured for a UE as part of DL carrier aggregation (CA) configuration, while the primary cell (PCell) needs to be on licensed spectrum. In Release 14 (Rel-14), LAA functionalities may be extended by introducing support also for LAA uplink (UL) transmissions on unlicensed spectrum.

The standardized LTE LAA approach in Rel-13 based on carrier aggregation (CA) framework assumes transmission of Uplink Control Information (UCI) on PCell, for example on licensed band. However, LAA may be expanded with dual connectivity operation, even in standalone LTE operation on unlicensed spectrum. This may allow for non-ideal backhaul between PCell in licensed spectrum and SCell(s) in unlicensed spectrum. LTE standalone operation on unlicensed spectrum means that the evolved Node B (eNB)/User Equipment (UE) air interface relies solely on unlicensed spectrum without any carrier on licensed spectrum.

In LTE operation on unlicensed carriers, depending on the regulatory rules, the UE may need to perform listen before talk (LBT) prior to UL transmission. To ensure reliable operation with LBT, transmissions may be required to occupy effectively the whole nominal channel BandWidth (BW). For example, the ETSI standards set strict requirements for the occupied channel bandwidth, such as “the Occupied Channel Bandwidth, defined to be the bandwidth containing 99% of the power of the signal, shall be between 80% and 100% of the declared Nominal Channel Bandwidth.” With a 20 MHz nominal channel bandwidth, this means that an LTE LAA transmission should have a bandwidth of at least 0.80*20 MHz=16 MHz. Additionally, regulations may also limit maximum allowed power spectral density. For example, PSD of only 11 or 10 dBm/MHz is allowed in significant portions of 5 GHz band in USA and Europe.

Thus, UL transmissions may be required to occupy a large BW. This can be achieved by means of IFDMA, Block Interleaved OFDMA (B-IFDMA) as described in 3GPP R1-152815, or contiguous resource allocation. B-IFDMA can be seen as a baseline uplink transmission scheme for LTE uplink transmission in unlicensed spectrum. For example, B-IFDMA is transmission scheme that can be used for both PUSCH and PUCCH.

FIG. 1 illustrates the principle of PUSCH transmission according to B-IFDMA on interlaces having 10 equally spaced clusters. In B-IFDMA, each allocation with subframe duration of 1 ms can include a large number of resource elements. For example, a single B-IFDMA interlace on a 20 MHz carrier can include 10 PRBs and 10×12×14=1680 resource elements. Such allocation may be too large for PUCCH. Due to flexible time division duplex (TDD) nature and HARQ-ACK feedback for all HARQ processes, around 10-60 UCI bits may need to be transmitted on PUCCH. Depending on spreading, a PUCCH format capable of carrying up to around 200 coded bits (assuming coding rate 0.3) may be needed, which may be roughly 1/12 of the capacity of a B-IFDMA interlace. 1680 resource elements can contain DMRS (e.g. 480 REs), and the remaining 1200 REs carry QPSK, corresponding to 2400 coded bits.

Furthermore, B-IFDMA structure with one out of 10 interlaces may result in rather large allocation for PUSCH data as well, which may be unnecessary with small data packets such as TCP Acknowledgements or VoIP traffic. This may limit multiplexing capacity.

In LTE, several code division multiple access (CDMA) methods can be used on PUCCH formats to balance the number used resource elements with targeted UCI payload and multiplexing capacity. In PUCCH Format 1/1a/1b, unmodulated/BPSK-modulated/QPSK-modulated symbol is spread with length-12 (reference signal) sequence. Users are multiplexed by allocating orthogonal cyclic shifts of the sequence to different users. User separation based on cyclic shifts is performed per each single carrier frequency division multiple access (SC-FDMA) symbol. In addition to spreading with length-12 sequence, orthogonal cover code is applied across SC-FDMA symbols. As a result, high multiplexing capacity is achieved for payloads of few bits. Format is used for HARQ-ACK and/or SR.

In PUCCH Format 2/2a/2b, QPSK-modulated symbol is spread with a length-12 (reference signal) sequence similarly as in PUCCH Format 1/1a/b. Users are multiplexed by allocating orthogonal cyclic shifts of the sequence to different users. Theses formats are used (mainly) for CQI reporting.

In PUCCH Format 3, only orthogonal cover code is applied across SC-FDMA symbols. Instead of length-12 sequence, each SC-FDMA symbol contains 12 QPSK-modulated symbols. Format is used for HARQ-ACK, SR and CSI reporting.

In PUCCH Format 4, no CDMA component is applied. Format is used for HARQ-ACK, SR and CSI reporting. In PUCCH Format 5, only orthogonal cover code is applied, but within a single SC-FDMA symbols. In other words, each SC-FDMA symbol contains 12 QPSK-modulated symbols. Format is used for HARQ-ACK, SR and CSI reporting.

From the data transmission point of view, LTE supports PUSCH transmission with down to 1 PRB granularity, which is one tenth of the resolution of B-IFDMA. In LTE, UL control signals (PUCCH) from one user cannot be multiplexed with UL data (PUSCH) of another user.

### SUMMARY

According to certain embodiments, a method can include determining whether a first type of uplink signal or a second type of uplink signal is to be processed for transmission on an interlace. The method can also include determining whether to apply spreading based on intra-symbol spreading codes, inter-symbol spreading codes, or both intra-symbol spreading codes and inter-symbol spreading codes, based on the determination of whether the first type of uplink signal or the second type of uplink signal is to be processed for transmission. The method can further include causing transmission of the determined at least one of the first type of uplink signal and the second type of uplink signal according to the determination regarding applying spreading.

In certain embodiments, an apparatus can include at least one processor and at least one memory including computer program code. The at least one memory and the computer program code can be configured to, with the at least one processor, cause the apparatus at least to determine whether a first type of uplink signal or a second type of uplink signal is to be processed for transmission on an interlace. The at least one memory and the computer program code can also be configured to, with the at least one processor, cause the apparatus at least to determine whether to apply spreading based on intra-symbol spreading codes, inter-symbol spreading codes, or both intra-symbol spreading codes and inter-symbol spreading codes, based on the determination of whether the first type of uplink signal or the second type of uplink signal is to be processed for transmission. The at least one memory and the computer program code can further be configured to, with the at least one processor, cause the apparatus at least to transmit the determined at least one of the first type of uplink signal and the second type of uplink signal according to the determination regarding applying spreading.

An apparatus, according to certain embodiments, can include means for determining whether a first type of uplink signal or a second type of uplink signal is to be processed for transmission on an interlace. The apparatus can also include means for determining whether to apply spreading based on intra-symbol spreading codes, inter-symbol spreading codes, or both intra-symbol spreading codes and inter-symbol spreading codes, based on the determination of whether the first type of uplink signal or the second type of uplink signal is to be processed for transmission. The apparatus can further include means for causing transmission of the determined at least one of the first type of uplink signal and the second type of uplink signal according to the determination regarding applying spreading.

According to certain embodiments, a method can include receiving an uplink signal on an interlace, the uplink signal comprising at least one of a first type of uplink signal and a second type of uplink signal. The method can also include processing the uplink signal based on whether spreading is applied to the uplink signal. Spreading can be applied to the uplink signal depending on whether the first type of uplink signal or a second type of uplink signal is to be processed for transmission on the interlace. The spreading can be applied based on intra-symbol spreading codes, inter-symbol spreading codes, or both intra-symbol spreading codes and inter-symbol spreading codes, based on whether the first type of uplink signal or the second type of uplink signal is transmitted.

In certain embodiments, an apparatus can include at least one processor and at least one memory including computer program code. The at least one memory and the computer program code can be configured to, with the at least one processor, cause the apparatus at least to receive an uplink signal on an interlace, the uplink signal comprising at least one of a first type of uplink signal and a second type of uplink signal. The at least one memory and the computer program code can also be configured to, with the at least one processor, cause the apparatus at least to process the uplink signal based on whether spreading is applied to the uplink signal. Spreading can be applied to the uplink signal depending on whether the first type of uplink signal or a second type of uplink signal is to be processed for transmission on the interlace. The spreading can be applied based on intra-symbol spreading codes, inter-symbol spreading codes, or both intra-symbol spreading codes and inter-symbol spreading codes, based on whether the first type of uplink signal or the second type of uplink signal is transmitted.

An apparatus, according to certain embodiments, can include means for receiving an uplink signal on an interlace, the uplink signal comprising at least one of a first type of uplink signal and a second type of uplink signal. The apparatus can also include means for processing the uplink signal based on whether spreading is applied to the uplink signal. Spreading can be applied to the uplink signal depending on whether the first type of uplink signal or a second type of uplink signal is to be processed for transmission on the interlace. The spreading can be applied based on intra-symbol spreading codes, inter-symbol spreading codes, or both intra-symbol spreading codes and inter-symbol spreading codes, based on whether the first type of uplink signal or the second type of uplink signal is transmitted.

A non-transitory computer-readable medium can, in accordance with certain embodiments, be encoded with instructions that, when executed in hardware, perform a process. The process can include determining whether a first type of uplink signal or a second type of uplink signal is to be processed for transmission on an interlace. The process can also include determining whether to apply spreading based on intra-symbol spreading codes, inter-symbol spreading codes, or both intra-symbol spreading codes and inter-symbol spreading codes, based on the determination of whether the first type of uplink signal or the second type of uplink signal is to be processed for transmission. The process can further include causing transmission of the determined at least one of the first type of uplink signal and the second type of uplink signal according to the determination regarding applying spreading.

A non-transitory computer-readable medium can, in accordance with certain embodiments, be encoded with instructions that, when executed in hardware, perform a process. The process can include receiving an uplink signal on an interlace, the uplink signal comprising at least one of a first type of uplink signal and a second type of uplink signal. The process can also include processing the uplink signal based on whether spreading is applied to the uplink signal. Spreading can be applied to the uplink signal depending on whether the first type of uplink signal or a second type of uplink signal is to be processed for transmission on the interlace. The spreading can be applied based on intra-symbol spreading codes, inter-symbol spreading codes, or both intra-symbol spreading codes and inter-symbol spreading codes, based on whether the first type of uplink signal or the second type of uplink signal is transmitted.

In certain embodiments, a computer program product can encode instructions for performing a process. The process can include determining whether a first type of uplink signal or a second type of uplink signal is to be processed for transmission on an interlace. The process can also include determining whether to apply spreading based on intra-symbol spreading codes, inter-symbol spreading codes, or both intra-symbol spreading codes and inter-symbol spreading codes, based on the determination of whether the first type of uplink signal or the second type of uplink signal is to be processed for transmission. The process can further include causing transmission of the determined at least one of the first type of uplink signal and the second type of uplink signal according to the determination regarding applying spreading.

In certain embodiments, a computer program product can encode instructions for performing a process. The process can include receiving an uplink signal on an interlace, the uplink signal comprising at least one of a first type of uplink signal and a second type of uplink signal. The process can also include processing the uplink signal based on whether spreading is applied to the uplink signal. Spreading can be applied to the uplink signal depending on whether the first type of uplink signal or a second type of uplink signal is to be processed for transmission on the interlace. The spreading can be applied based on intra-symbol spreading codes, inter-symbol spreading codes, or both intra-symbol spreading codes and inter-symbol spreading codes, based on whether the first type of uplink signal or the second type of uplink signal is transmitted.

### BRIEF DESCRIPTION OF THE DRAWINGS

For proper understanding of the invention, reference should be made to the accompanying drawings, wherein:

FIG. 1 illustrates the principle of PUSCH transmission according to B-IFDMA on interlaces having 10 equally spaced clusters.

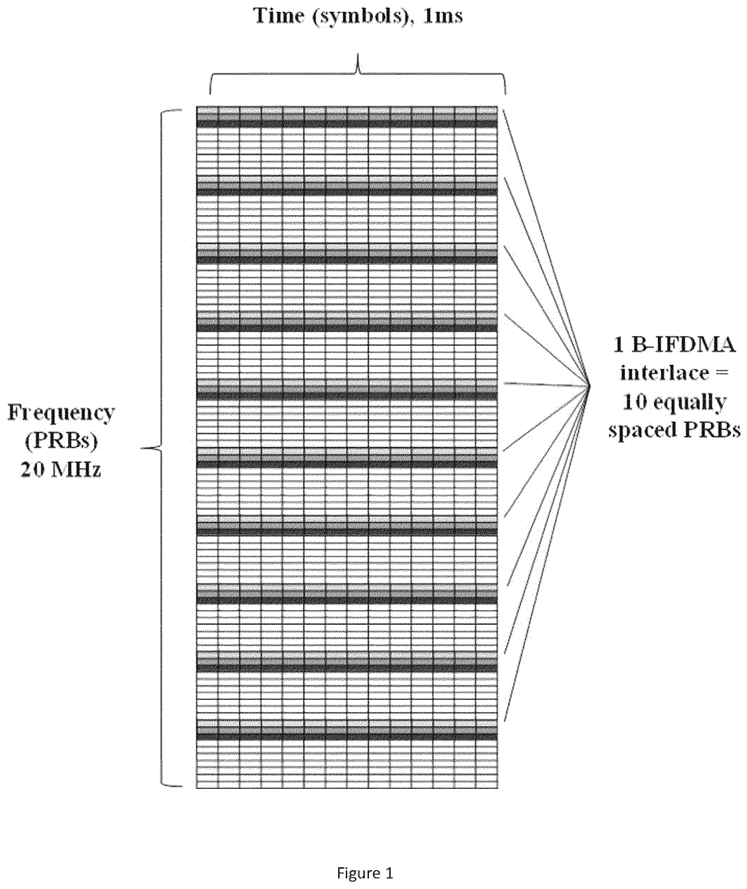

FIG. 2 illustrates a table in which there are configuration combinations that can be orthogonally multiplexed on the same interlace, according to certain embodiments.

FIG. 3 illustrates the channelization within the B-IFDMA interlace for cases with UEs control signals only, according to certain embodiments.

FIG. 4 illustrates the channelization within the B-IFDMA interlace for cases with UEs with small (sub-interlace) data transmissions, according to certain embodiments.

FIG. 5 illustrates the channelization within the B-IFDMA interlace for cases with a mix of UEs with control and UEs with small data transmissions, according to certain embodiments.

FIG. 6 illustrates the channelization within the B-IFDMA interlace for cases with UEs with a data transmission occupying intra symbol spreading within an interlace, according to certain embodiments.

FIG. 7 illustrates channelization in scenarios having a mix of UEs with control and data transmissions, according to certain embodiments.

FIG. 8 illustrates a method according to certain embodiments.

FIG. 9 illustrates another method according to certain embodiments.

FIG. 10 illustrates a system according to certain embodiments.

### DETAILED DESCRIPTION

None of the existing LTE formats may meet the needs of certain physical uplink control channel (PUCCH) implementations. Moreover, such LTE formats may not be able to be extended in a trivial way, such that targeted PUCCH payload range and high multiplexing capacity are met. Further, spreading that maintains orthogonality with reasonable receiver complexity and is well suited for DFT-S-OFDMA may be beneficial. Certain embodiments of the present invention may address these and other issues.

Both dual connectivity and standalone operation modes may rely on transmission of UCI/physical uplink control channel (PUCCH) on unlicensed spectrum. Certain embodiments may provide UL transmission formats for small data or control signal payloads suitable for unlicensed spectrum. Moreover, certain embodiments may provide PUCCH formats suitable for unlicensed spectrum while supporting reasonable payload together with high multiplexing capacity.

Certain embodiments provide multiplexing and resource-element mapping mechanisms that are well-suited for DFT-S-OFDMA. These mechanisms may maintain orthogonality between users with reasonable receiver complexity. Additionally, these mechanisms may support flexible configuration of payload size/multiplexing capacity. Multiplexing can include both CDMA and FDMA components and can support users with only UL-control signaling, or also with UL data.

In the CDMA component, the block spreading method can spread, depending on the configuration, different signal elements. The same block spreading method can be applied either to spread a group of modulation symbols constituting a whole DFT-S-OFDMA symbol, which can be referred to as inter DFT-S-OFDMA symbol spreading, or to spread a group of modulation symbols which are mapped after spreading into a single DFT-S-OFDMA symbol, which can be referred to as intra DFT-S-OFDMA symbol spreading, or to spread both cases.

In certain embodiments, orthogonal cover code (OCC) can be used for the block spreading. The OCC can be enabled and configured independently for both intra-symbol and inter-symbol spreading.

In the FDMA component, the coded and block-spread symbols can converted to frequency domain with discrete Fourier transform (DFT), and resulting signal can be mapped onto equally spaced PRBs according to Block Interleaved OFDMA allocation.

Certain embodiments can facilitate multiplexing of UL control signals and UL data from different UEs on the same Block IFDMA interlace.

For example, in certain embodiments, for UL data, for example PUSCH, only either intra- or inter-symbol spreading is used within the B-IFDMA interlace, but not both. Moreover, for UL control signals, both intra- or inter-symbol spreading can be applied within the B-IFDMA interlace.

This arrangement can ensure that UL data and UL control signals can be orthogonally multiplexed on the same B-IFDMA interlace. The orthogonal multiplexing may be applied also on different categorization of signals. For example, intra- or inter-symbol spreading may be applied for UL control signals comprising only HARQ-ACK or HARQ-ACK and SR, while either intra- or inter-symbol spreading can be applied for a signal comprising UL data and/or UL control signal comprising at least CSI reporting and potentially other UL control signal types like HARQ-ACK and SR.

Certain embodiments provide an arrangement that allows flexible configuration of various data payloads to different UEs. Taking 1 ms PUCCH mapped on B-IFDMA 10 PRBs, the following number of coded bits can be supported: intra-symbol spreading of 1080-1200 coded bits; inter-symbol spreading of 480 coded bits; and intra-symbol & inter-symbol spreading: 240 coded bits.

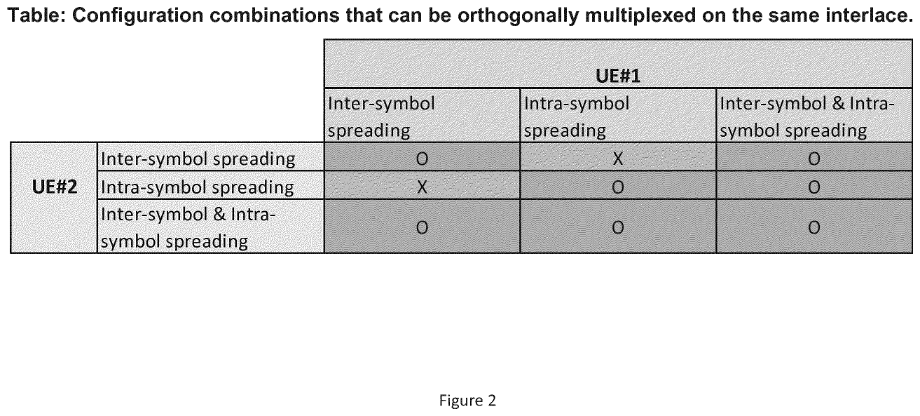

FIG. 2 illustrates a table in which there are configuration combinations that can be orthogonally multiplexed on the same interlace, according to certain embodiments. With certain embodiments, UEs with different spreading configuration can be orthogonally multiplexed on the same interlace as shown in the table of FIG. 2. As shown in FIG. 2, the only exception is the combination of inter-symbol and intra-symbol spreading, marked with an “X”.

The relationship between resource index and intra and/or inter symbol spreading code can be determined based on predefined table and/or equation. Indexes may be defined separately for each B-IFDMA interlace (as indicated in the figures discussed below). Another option is to define a common indexing scheme for multiple/all B-IFDMA interlaces. The indexing scheme can be defined separately for data and control channels.

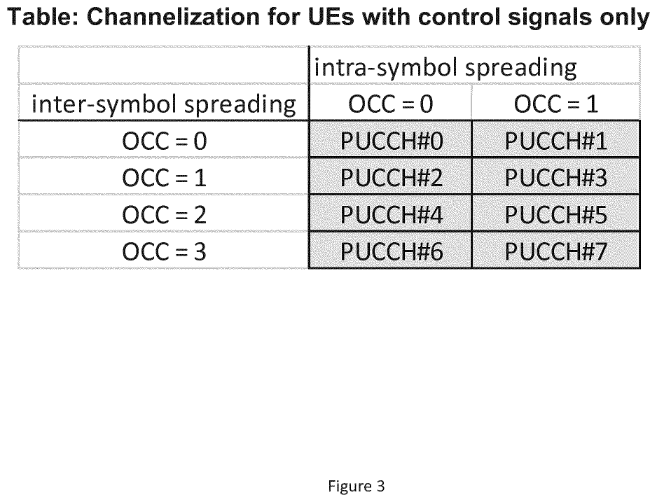

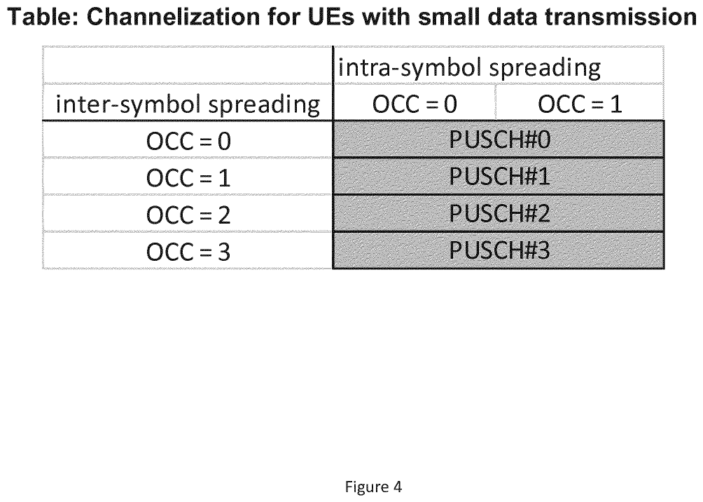

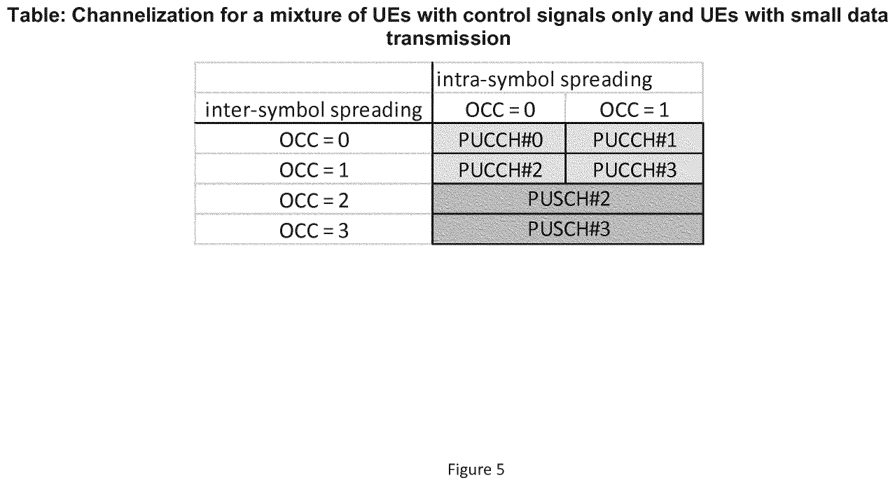

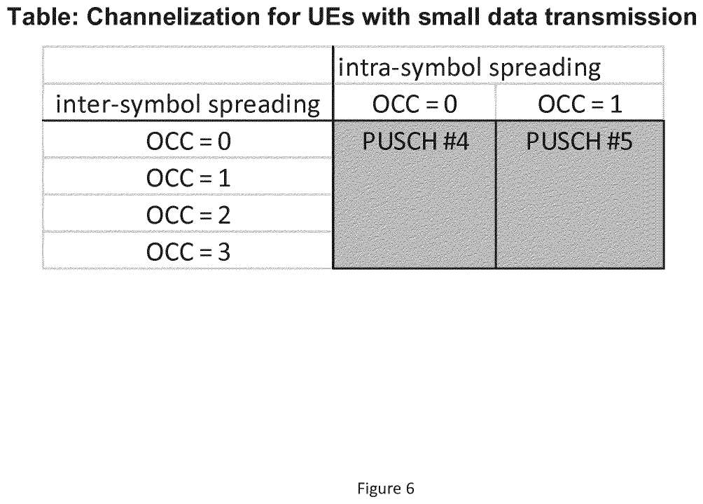

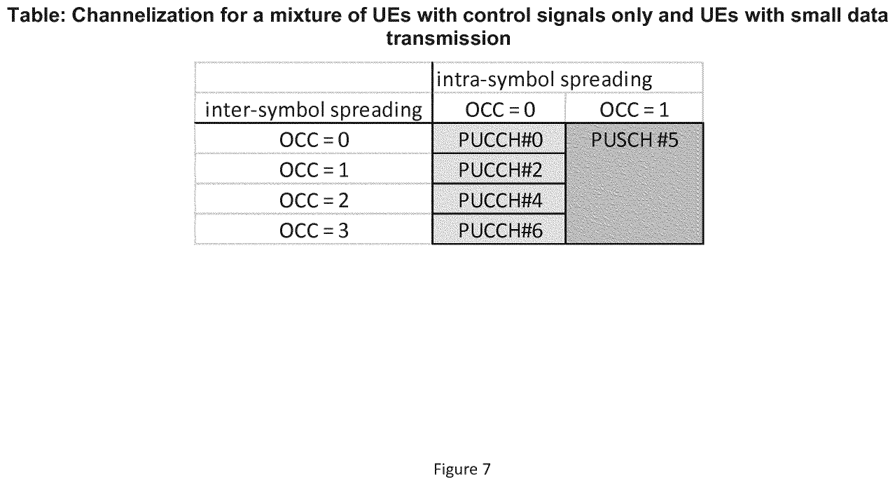

The tables in FIG. 3 through 7 provide various channelizations for various configurations. FIG. 3 illustrates the channelization within the B-IFDMA interlace for cases with UEs control signals only, according to certain embodiments. There are in total 8 parallel channels available within a B-IFDMA interlace. They are indicated as channel indexes #0, #1, . . . , #7. It should be noted that the considered indexing scheme is just a non-limiting example and it covers just one B-IFDMA interlace. FIG. 4 illustrates the channelization within the B-IFDMA interlace for cases with UEs with small (sub-interlace) data transmissions, according to certain embodiments. FIG. 5 illustrates the channelization within the B-IFDMA interlace for cases with a mix of UEs with control and UEs with small data transmissions, according to certain embodiments. Based on the indexing scheme of certain embodiments, PUCCH indexing does not depend on the presence of PUSCH. FIG. 6 illustrates the channelization within the B-IFDMA interlace for cases with UEs with a data transmission occupying intra symbol spreading within an interlace, according to certain embodiments. FIG. 7 illustrates channelization in scenarios having a mix of UEs with control and data transmissions, according to certain embodiments. It can be noted that FIG. 4 FIG. 7 apply common indexing scheme for PUSCH. A baseline scenario not covered by examples shown in FIG. 3-5 is to allocate one or more B-IFDMA interlaces for PUSCH without any spreading. This could be seen as an additional PUSCH index.

As can be seen from FIG. 3-7, certain embodiments allow for flexible multiplexing of UEs with various types of UL data or control traffic. Hence, certain embodiments may help in minimizing the fragmentation of UL resources. In turn such minimization of fragmentation may minimize UL overhead.

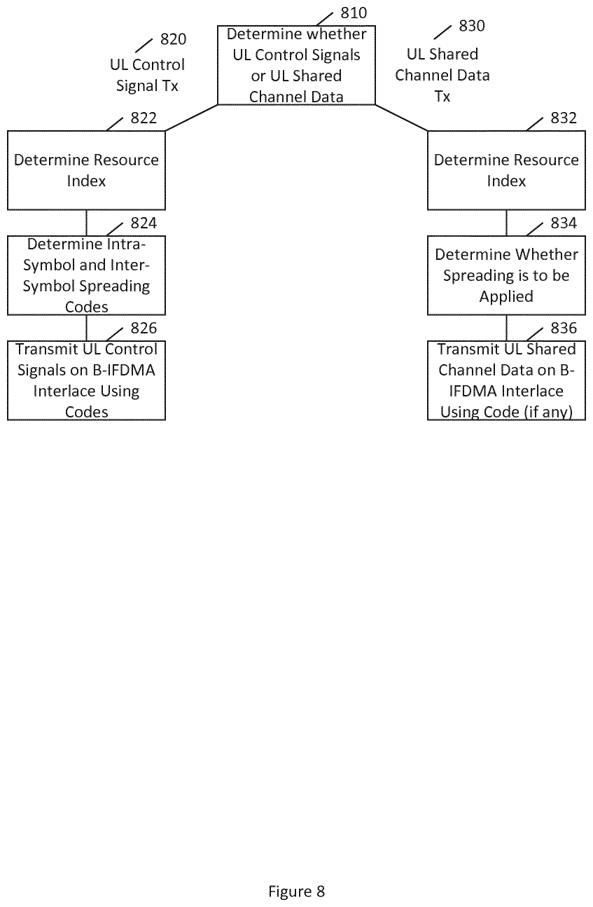

FIG. 8 illustrates a method according to certain embodiments. As shown in FIG. 8, a method can include, at 810, determining whether UL control signals or UL shared channel data is to be transmitted on a B-IFDMA interlace.

In case of UL control signal transmission (Tx) 820, the method can include, at 822, determining the resource index. The method can also include, at 824, based on the resource index, determining the intra-symbol and inter-symbol spreading codes. The method can further include, at 826, causing transmission of the UL controls signals on the B-IFDMA interlace using the determined the intra-symbol and inter-symbol spreading codes.

In case of UL shared channel data transmission (Tx) 830, the method can include, at 832, determining the resource index. The method can also include, at 834, determining whether spreading is to be applied or not. The spreading may involve either the intra-symbol or inter-symbol spreading code, but not both. The method can further include, at 836, causing transmission of the UL shared channel data on the B-IFDMA interlace using the determined spreading code, if any.

In an alternative embodiment, IFDMA can be used as alternative for intra-symbol orthogonal cover code (OCC), resulting in OCC-spread block-interleaved interleaved FDMA.

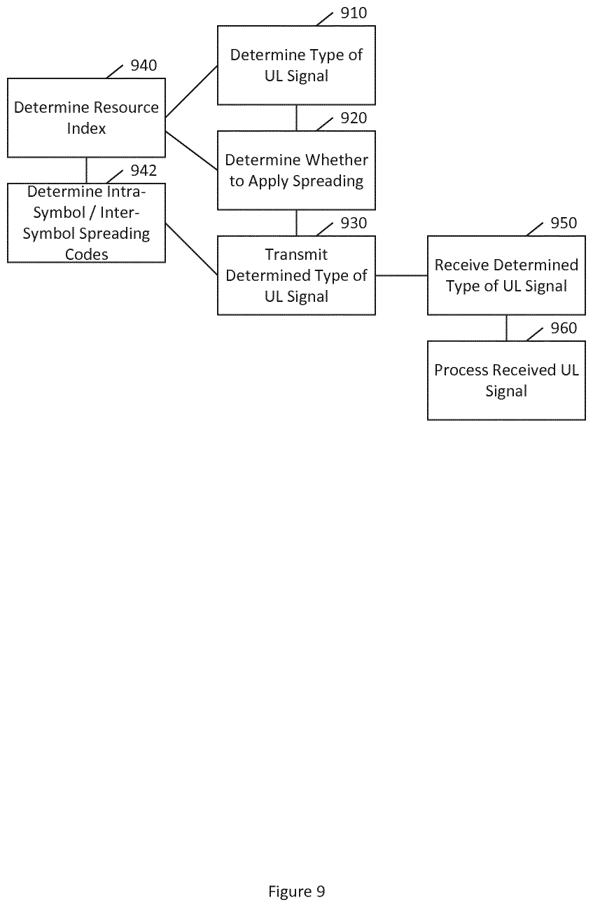

FIG. 9 illustrates another method according to certain embodiments. FIG. 8 can be considered as an example implementation of the method more generally illustrated in FIG. 9. The method of FIG. 9 may be used in accordance with a variety of embodiments, such as those illustrated in FIGS. 2-7.

As shown in FIG. 9, a method can include, at 910, determining whether a first type of uplink signal or a second type of uplink signal is to be processed for transmission on an interlace. The method can also include, at 920, determining whether to apply spreading based on intra-symbol spreading codes, inter-symbol spreading codes, or both intra-symbol spreading codes and inter-symbol spreading codes, based on the determination of whether the first type of uplink signal or the second type of uplink signal is to be processed for transmission. The method can further include, at 930, causing transmission of the determined at least one of the first type of uplink signal and the second type of uplink signal according to the determination regarding applying spreading.

The first type can be uplink control signal and the second type can be uplink shared channel data. Alternatively, the first type can be uplink control signal comprising only HARQ-ACK or HARQ-ACK and SR, and the second type can be uplink shared channel data or uplink control signal comprising at least aperiodic CSI reporting. The interlace can be a block interleaved frequency division multiple access interlace, as described above.

When it is determined at 910 that the first type of uplink signal is to be processed for transmission, the method can further include, at 940, determining a resource index and, at 942, determining the intra-symbol spreading code(s) and the inter-symbol spreading codes based on the resource index. The causing transmission at 930 can, in this case, include causing transmission of the first type of uplink signal on the interlace using the determined the intra-symbol and inter-symbol spreading codes.

When it is determined at 910 that the second type of uplink signal is to be processed for transmission, the method can further include causing transmission of the second type of uplink signal on the interlace at 930, using a determined spreading code, if any is determined. The method can also include, at 940, determining a resource index and, at 920, determining whether spreading is to be applied or not, based on the resource index. In this case the spreading, if any is determined, can involve either the intra-symbol spreading codes or the inter-symbol spreading codes, but not both the intra-symbol spreading codes and the inter-symbol spreading codes.

The above described features may be performed by, for example, a user equipment. The UL signal generated by the user equipment may be wireless transmitted at 930, as mentioned above. At 950, the UL signal may be received at an access node, such as base station, evolved Node B (eNB), or other access point. The receiving at 950, therefore, can include receiving an uplink signal on an interlace, the uplink signal include at least one of a first type of uplink signal and a second type of uplink signal. This may be the same interlace, and same first type and/or second type described above.

The method can also include, at 960, processing the uplink signal based on whether spreading is applied to the uplink signal. As described above, spreading can be applied to the uplink signal depending on whether the first type of uplink signal or a second type of uplink signal is to be processed for transmission on the interlace. The spreading can be applied based on intra-symbol spreading codes, inter-symbol spreading codes, or both intra-symbol spreading codes and inter-symbol spreading codes, based on whether the first type of uplink signal or the second type of uplink signal is transmitted. In short, the processing at 960 can take into account the various features and options possible with respect to any of the UE determinations described above.

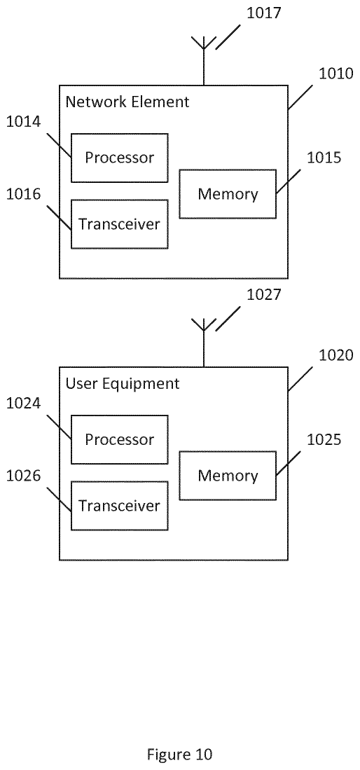

FIG. 10 illustrates a system according to certain embodiments of the invention. It should be understood that each block of the flowchart of FIGS. 8 and 9 may be implemented by various means or their combinations, such as hardware, software, firmware, one or more processors and/or circuitry. In one embodiment, a system may include several devices, such as, for example, network element 1010 and user equipment (UE) or user device 1020. The system may include more than one UE 1020 and more than one network element 1010, although only one of each is shown for the purposes of illustration. A network element can be an access point, a base station, an eNode B (eNB), or any other network element, such as a PCell base station or an SCell base station.

Each of these devices may include at least one processor or control unit or module, respectively indicated as 1014 and 1024. At least one memory may be provided in each device, and indicated as 1015 and 1025, respectively. The memory may include computer program instructions or computer code contained therein, for example for carrying out the embodiments described above. One or more transceiver 1016 and 1026 may be provided, and each device may also include an antenna, respectively illustrated as 1017 and 1027. Although only one antenna each is shown, many antennas and multiple antenna elements may be provided to each of the devices. Other configurations of these devices, for example, may be provided. For example, network element 1010 and UE 1020 may be additionally configured for wired communication, in addition to wireless communication, and in such a case antennas 1017 and 1027 may illustrate any form of communication hardware, without being limited to merely an antenna.

Transceivers 1016 and 1026 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. It should also be appreciated that according to the “liquid” or flexible radio concept, the operations and functionalities may be performed in different entities, such as nodes, hosts or servers, in a flexible manner. In other words, division of labor may vary case by case. One possible use is to make a network element to deliver local content. One or more functionalities may also be implemented as a virtual application that is provided as software that can run on a server.

A user device or user equipment 1020 may be a mobile station (MS) such as a mobile phone or smart phone or multimedia device, a computer, such as a tablet, provided with wireless communication capabilities, personal data or digital assistant (PDA) provided with wireless communication capabilities, smart watch, portable media player, digital camera, pocket video camera, navigation unit provided with wireless communication capabilities or any combinations thereof. The user device or user equipment 1020 may be a sensor or smart meter, or other device that may usually be configured for a single location.

In an exemplifying embodiment, an apparatus, such as a node or user device, may include means for carrying out embodiments described above in relation to FIGS. 8 and 9.

Processors 1014 and 1024 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof.

For firmware or software, the implementation may include modules or units of at least one chip set (e.g., procedures, functions, and so on). Memories 1015 and 1025 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network element 1010 and/or UE 1020, to perform any of the processes described above (see, for example, FIGS. 8 and 9). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

Furthermore, although FIG. 10 illustrates a system including a network element 1010 and a UE 1020, embodiments of the invention may be applicable to other configurations, and configurations involving additional elements, as illustrated and discussed herein. For example, multiple user equipment devices and multiple network elements may be present, or other nodes providing similar functionality, such as nodes that combine the functionality of a user equipment and an access point, such as a relay node.

Certain embodiments may have various benefits and/or advantages. For example, certain embodiments may provide a multiplexing method that supports UL control channel format supporting reasonable payload while supporting high multiplexing capacity and meeting unlicensed spectrum requirements. The multiplexing method may allow for flexible multiplexing of UEs with various types of UL data or control traffic. Additionally, the multiplexing method may minimize the fragmentation of UL resources.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### LIST OF ABBREVIATIONS

3GPP Third Generation Partnership Project

ACK Acknowledgement

BW Bandwidth

CA Carrier Aggregation

CCE Control Channel Element

CRC Cyclic Redundancy Check

CSI Channel State Information

DL Downlink

DMRS Demodulation Reference Signal

DTX Discontinuous Transmission

eNB Evolved NodeB

ETSI European Telecommunications Standards Institute

FDD Frequency Division Duplex

FDM Frequency Division Multiplex

HARQ Hybrid Automatic Repeat Request

IFDMA Interleaved Frequency Division Multiple Access

LAA Licensed Assisted Access

LBT Listen-Before-Talk

LTE Long Term Evolution

NACK Negative Acknowledgement

NDI New Data Indicator

OFDMA Orthogonal Frequency Division Multiple Access

OCC Orthogonal Cover Code

SC-FDMA Single-Carrier Frequency Division Multiple Access

PCell Primary cell

PDSCH Physical Downlink Shared Control Channel

PUCCH Physical Uplink Control Channel

PUSCH Physical Uplink Shared Channel

RPF RePetition Factor

SCell Secondary cell (operating on un-licensed carrier in this IPR)

SR Scheduling Request

TB Transmission Block

TDD Time Division Duplex

TDM Time Division Multiplex

TX Transmission

TXOP Transmission Opportunity

UCI Uplink Control Information

UE User Equipment

UL Uplink

1.-38. (canceled)

39. A method, comprising:
determining whether a first type of uplink signal or a second type of uplink signal is to be processed for transmission on an interlace;
determining whether to apply spreading based on intra-symbol spreading codes, inter-symbol spreading codes, or both intra-symbol spreading codes and inter-symbol spreading codes, based on the determination of whether the first type of uplink signal or the second type of uplink signal is to be processed for transmission; and
causing transmission of the determined at least one of the first type of uplink signal and the second type of uplink signal according to the determination regarding applying spreading.

40. The method of claim 39, wherein the first type comprises uplink control signal.

41. The method of claim 39, wherein the second type comprises uplink shared channel data.

42. The method of claim 39, wherein the interlace comprises a block interleaved frequency division multiple access interlace.

43. The method of claim 39, wherein, when it is determined that the first type of uplink signal is to be processed for transmission, the method further includes:
determining a resource index; and
determining the intra-symbol spreading code and the inter-symbol spreading code based on the resource index,
wherein the causing transmission comprises causing transmission of the first type of uplink signal on the interlace using the determined intra-symbol and inter-symbol spreading codes.

44. The method of claim 39, wherein, when it is determined that the second type of uplink signal is to be processed for transmission, the method further includes:
causing transmission of the second type of uplink signal on the interlace, using a determined spreading code, if any is determined.

45. An apparatus, comprising:
at least one processor; and
at least one memory including computer program code,
wherein the at least one memory and the computer program code are configured to, with the at least one processor, cause the apparatus at least to
determine whether a first type of uplink signal or a second type of uplink signal is to be processed for transmission on an interlace;
determine whether to apply spreading based on intra-symbol spreading codes, inter-symbol spreading codes, or both intra-symbol spreading codes and inter-symbol spreading codes, based on the determination of whether the first type of uplink signal or the second type of uplink signal is to be processed for transmission; and
cause transmission of the determined at least one of the first type of uplink signal and the second type of uplink signal according to the determination regarding applying spreading.

46. The apparatus of claim 45, wherein the first type comprises uplink control signal.

47. The apparatus of claim 45, wherein the second type comprises uplink shared channel data.

48. The apparatus of claim 45, wherein the interlace comprises a block interleaved frequency division multiple access interlace.

49. The apparatus of claim 45, wherein, when it is determined that the first type of uplink signal is to be processed for transmission, the at least one memory and the computer program code are configured to, with the at least one processor, cause the apparatus at least to:
determine a resource index; and
determine the intra-symbol spreading code and the inter-symbol spreading code based on the resource index,
wherein the causing transmission comprises causing transmission of the first type of uplink signal on the interlace using the determined the intra-symbol and inter-symbol spreading codes.

50. The apparatus of claim 45, wherein, when it is determined that the second type of uplink signal is to be processed for transmission, the at least one memory and the computer program code are configured to, with the at least one processor, cause the apparatus at least to cause transmission of the second type of uplink signal on the interlace, using a determined spreading code, if any is determined.

51. The apparatus of claim 50, wherein the at least one memory and the computer program code are configured to, with the at least one processor, cause the apparatus at least to
determine a resource index; and
determine whether spreading is to be applied or not, based on the resource index.

52. The apparatus of claim 50, wherein the spreading, if any is determined, involves either the intra-symbol spreading codes or the inter-symbol spreading codes, but not both the intra-symbol spreading codes and the inter-symbol spreading codes.

53. A method, comprising:
receiving an uplink signal on an interlace, the uplink signal comprising at least one of a first type of uplink signal and a second type of uplink signal; and
processing the uplink signal based on whether spreading is applied to the uplink signal,
wherein spreading is applied to the uplink signal depending on whether the first type of uplink signal or a second type of uplink signal is to be processed for transmission on the interlace,
wherein the spreading is applied based on intra-symbol spreading codes, inter-symbol spreading codes, or both intra-symbol spreading codes and inter-symbol spreading codes, based on whether the first type of uplink signal or the second type of uplink signal is transmitted.

54. An apparatus, comprising:
at least one processor; and
at least one memory including computer program code,
wherein the at least one memory and the computer program code are configured to, with the at least one processor, cause the apparatus at least to
receive an uplink signal on an interlace, the uplink signal comprising at least one of a first type of uplink signal and a second type of uplink signal; and
process the uplink signal based on whether spreading is applied to the uplink signal,
wherein spreading is applied to the uplink signal depending on whether the first type of uplink signal or a second type of uplink signal is to be processed for transmission on the interlace,
wherein the spreading is applied based on intra-symbol spreading codes, inter-symbol spreading codes, or both intra-symbol spreading codes and inter-symbol spreading codes, based on whether the first type of uplink signal or the second type of uplink signal is transmitted.

55. The apparatus of claim 54, wherein the first type comprises uplink control signal.

56. The apparatus of claim 54, wherein the second type comprises uplink shared channel data.

57. The apparatus of claim 54, wherein the interlace comprises a block interleaved frequency division multiple access interlace.

58. A non-transitory computer-readable medium encoded with instructions that, when executed in hardware, perform a process, the process comprising the method according to claim 39.
